(19) United States
(12) Patent Application Publication
(10) Pub. No.: US 2024/0284946 A1
(43) Pub. Date: Aug. 29, 2024

(54) SINGLE CHAMBER AIR POPPER

(71) Applicant: National Presto Industries, Inc., Eau Claire, WI (US)

(72) Inventors: Jesse Kukuk, Eau Claire, WI (US); Michael R. Berge, Eau Claire, WI (US)

(21) Appl. No.: 18/114,624

(22) Filed: Feb. 27, 2023

(51) Int. Cl. A23L 7/187

(52) U.S. Cl. CPC A23L 7/187

(57) ABSTRACT

Disclosed is single chamber hot air corn popper that includes a base with a blower and heater that blows air into a recessed popping chamber in which popcorn is present. The hot air corn popper is configured so that as the popcorn pops it is retained in a bowl assembly that facilitates the return of unpopped popcorn kernels present in the popped corn to the popping chamber for continued exposure to the hot air to improve the popping efficiency of the hot air popper as compared to conventional hot hair corn poppers.

### CROSS REFERENCE TO RELATED APPLICATIONS

This application makes no claim of priority.

### TECHNICAL FIELD

The present invention is directed to the field of small electrical appliances. More specifically, the present invention is directed to popcorn poppers using heated air to pop popcorn and having a single popping chamber in which the popped kernels are retained during the popping process.

### BACKGROUND

Popcorn is a popular snack that is produced by heating kernels of corn until the moisture within the corn turns to steam causing the shell of the kernel to crack and the starchy contents to rapidly expand into a crunchy snack. Methods of preparing popcorn include hot oil poppers, microwave poppers, and hot air poppers. Poppers that utilize hot oil to heat the unpopped kernel add a certain amount of fat content to the popcorn as a result of a portion of the oil remaining on the popped snack. Microwave poppers and hot air poppers provide the benefit of a popped corn product that is lower in fat than traditional methods resulting from the lack of a need to pop the popcorn kernels using hot oil. This can be a significant benefit to someone who wishes to limit the use of fats and oils in their foods. Hot air popcorn poppers cook the kernels by subjecting them to a stream of heated air. Unfortunately, the stream of air in many hot air popcorn makers can blow unpopped kernels into those kernels that have been popped, introducing unpopped kernels into the resultant snack. This can also result from the unpopped kernels being captured and suspended within the popped kernels and blown out of conventional hot-air popcorn poppers into a serving bowl. Methods have been implemented such as discharge chutes or baffles and gratings to reduce the likelihood that unpopped kernels remain with the popped kernels however, these methods can be costly and result in a larger popper or difficult-to-clean bowls. What is needed is a popcorn popper that increases the number of unpopped kernels that re-enter the popping chamber for continued exposure to hot air.

### SUMMARY

Embodiments relate to devices for and method of popping popcorn using hot air. More specifically, exemplary embodiments of devices for popping popcorn include a base and inverted container placed on the base into which the popped popcorn is introduced and retained.

A popcorn popper according to an exemplary embodiment comprises a container formed by a bowl, a popping flange, and a popping chamber wherein both popped and unpopped popcorn are present in the container during use. In exemplary embodiments, the container is configured to retain the popped popcorn until the popping of the unpopped corn is complete. The popping flange of exemplary embodiments being configured to direct unpopped popcorn located within the container back into the popping chamber until the popping of the unpopped popcorn is complete. Certain exemplary embodiments also comprise a source of heated air, the heated air being directed into the popping chamber before passing through the container and exiting via an air exit formed in the bowl.

In an exemplary embodiment, a device for popping popcorn comprises a base assembly that itself comprises a diffuser, a blower, a heater, and a popping flange, the blower configured to force air through the heater and diffuser. The exemplary embodiment also having a bowl assembly which comprising a bowl having a first end and a second end, the second end being configured with vents and the first end having an opening that spans the diameter of the bowl, the first end of the bowl being adapted to be positioned on the popping flange such that the bowl and popping flange form a container which retains popped and unpopped corn during a popping process.

In another exemplary embodiment, a method of popping corn comprises placing unpopped corn into a diffuser, the diffuser comprising vent slots, and positioned on a concave popping flange. The method comprising positioning a bowl portion having an open end and a grated end such that the open end is covered with the popping flange to form a container. The method comprising causing heated air to flow through the vent slots of the diffuser such that the unpopped corn is subjected to sufficient heat that the unpopped corn pops to form popcorn. The exemplary method comprises capturing the popcorn in the container such that the popcorn is agitated by the heated air and the popping corn, directing unpopped corn present in the container back into the diffuser for additional exposure to heated air. The exemplary method further comprising positioning the bowl portion such that the popcorn is retained in the bowl portion by the force of gravity and removing the popping flange from the open end of the bowl portion.

The above summary is not intended to describe each illustrated embodiment or every implementation of the invention. Rather, the exemplary embodiments are chosen and described to provide an overview or framework for understanding the nature and character of the claimed aspects and implementations so that those skilled in the art can appreciate and understand the principles and practices of the invention. The Figures and the detailed description that follow more particularly exemplify these exemplary embodiments, and are incorporated in and constitute a part of this specification.

### BRIEF DESCRIPTION OF THE DRAWINGS

These and other features and advantages of the present invention will become better understood with regard to the following description and accompanying drawings in which:

FIG. 1 is a perspective view of a hot air corn popper according to an exemplary embodiment;

FIG. 2 is an exploded view of a hot air corn popper of FIG. 1;

FIG. 3 is a perspective view of the hot air corn popper of FIG. 1 shown in a storage configuration.

FIG. 4 is a partially exploded view of the corn popper configuration of FIG. 3;

FIG. 5 is a perspective view of a base portion of the hot air corn popper of FIG. 1;

FIG. 6 is a cross-section view of the popping flange portion of the hot air corn popper of FIG. 1;

FIG. 6a is a portion of the cross-section view of FIG. 6 illustrating the slope of the popping flange in an exemplary embodiment; and

FIG. 7 illustrates a flow chart of the operation of an exemplary embodiment of a hot air corn popper.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

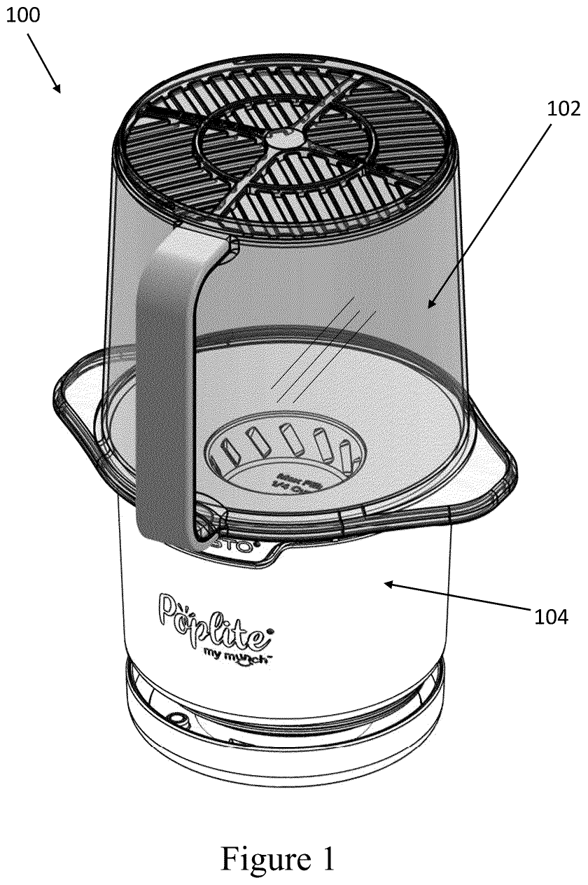

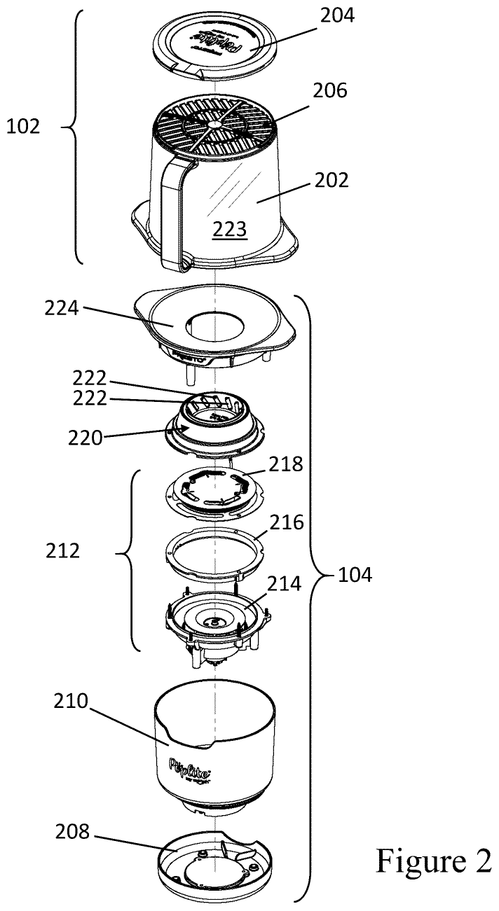

As illustrated in FIG. 1, an exemplary embodiment of a hot air popper 100 comprises a base assembly 102 and a bowl assembly 104. FIG. 2 shows an exploded view of the hot air popper 100 to illustrate the various components which comprise the base assembly 102 and bowl assembly 104. As shown, bowl assembly 102 comprises a bowl 202 and a lid 204. In an exemplary embodiment, the lid 204 snaps onto the bowl 202 using a raised rim or other attachment features such as clips, slots and tabs, magnets, or threads. Also illustrated is a hot air exit grating 206 which serves to contain popped corn within a container area 223 formed partially by the bowl 202 while allowing a stream of heated air to flow through the bowl 202 and escape through the hot air exit grating 206 when the hot air popper 100 is in use.

The base assembly 104 comprises a cord storage ring 208, a base enclosure 210, a motor/heater assembly 212 which comprises a blower 214, a spacer 216, a heater 218, and a popping cone which further comprises a funnel-shaped diffuser 220. Not illustrated is a power cord that serves to deliver electrical power to the blower 214 and heater 218 such that the hot air popper 100 functions.

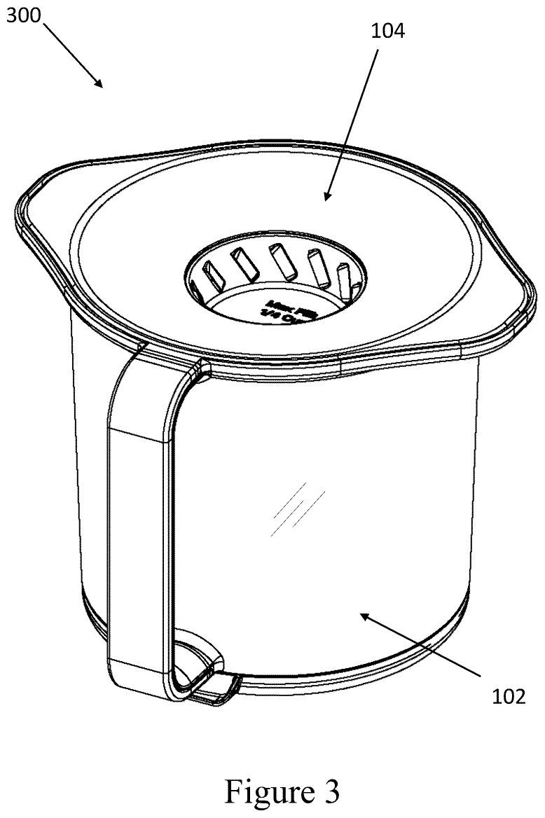

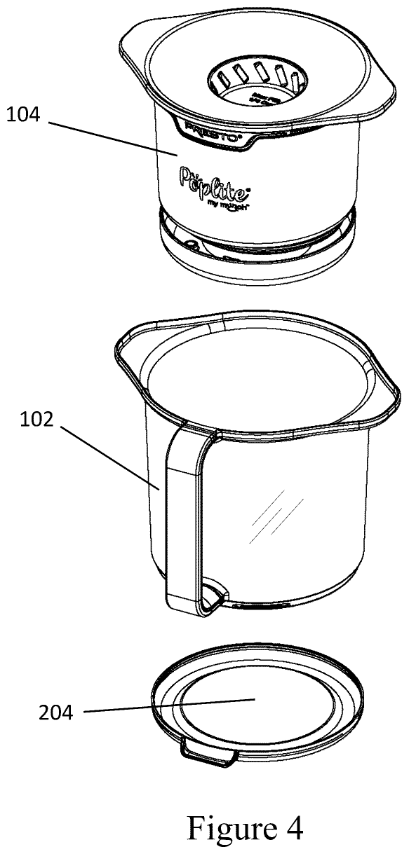

FIG. 3 shows an exemplary embodiment of the hot air popper in a storage configuration 300. As shown, the base assembly 104 is insertable into an inverted bow assembly 102 for storage. FIG. 4 shows the hot air corn popper 300 of FIG. 3 in a partially exploded arrangement such that the inverted bowl 102 and snap-on lid 204 are clearly illustrated in a position to receive the base 104 for storage.

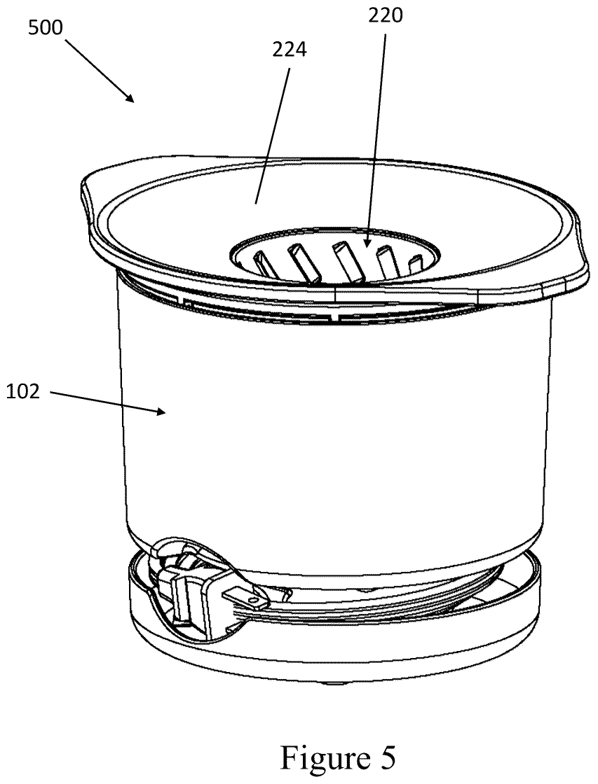

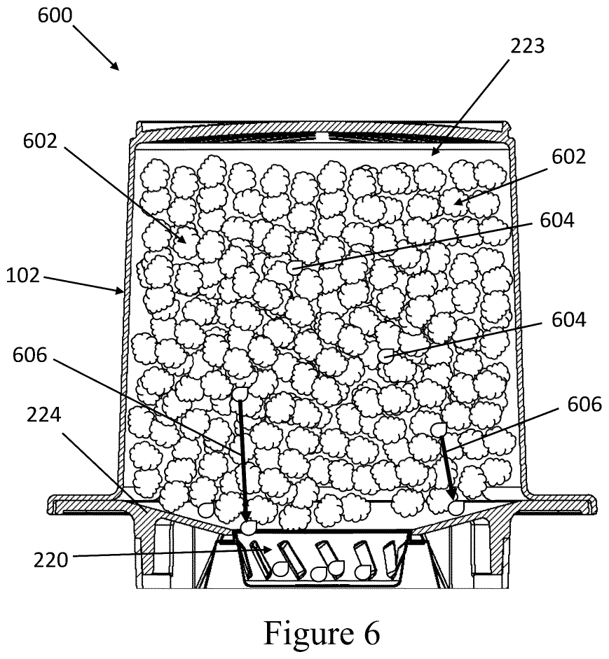

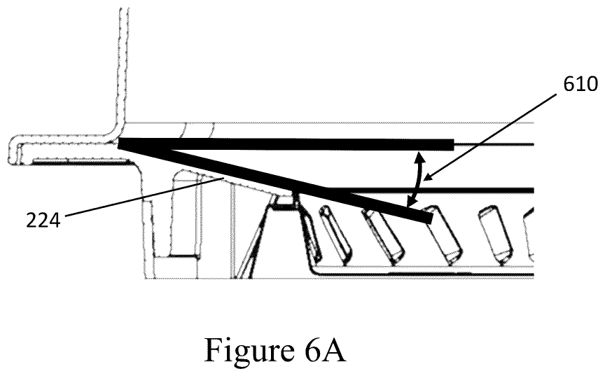

FIG. 5 represents a perspective view 500 of the base assembly 102 showing the diffuser 220 and popping flange 224. Referring to FIG. 6, when in use the diffuser 220 serves to hold unpopped corn and direct heated air at the unpopped corn through a series of angled vent slots 222. Hot air is directed by the motor 214 through the heater 218 and into the diffuser 220 through the vent slots 222. In use, unpopped corn is placed in the diffuser 220 where the heated air causes moisture present in the unpopped corn to form hot gasses inside the unpopped corn, causing the corn to pop and form popcorn. The explosive popping action of the corn causes the corn to be ejected 602 from the diffuser 220 into a container 223 formed by the bowl and a popping flange 224 whereupon heated air tends to act to keep the now enlarged, popped kernels out of the diffuser 200. In use, the process of popcorn being ejected from the diffuser 220 tends to capture and carry unpopped kernels 604 out of the diffuser 220 and into the container 223. Known embodiments direct the popped corn into a storage area or bowl, a configuration that doesn't allow the unpopped kernels to reenter the stream of hot air. The result being that a number of unpopped kernels are either mixed in with the popped corn or settle to the bottom of a serving bowl. This unpopped corn is wasteful and can result in an unsatisfactory experience for consumers of the popped (and unpopped) kernels.

As shown in FIG. 6, a popping flange 224 is positioned at the upper end of the diffuser 220. As illustrated in FIGS. 3 and 4, the popping flange 224 is positioned such that the upper surface of the diffuser 220 is flush with or slightly recessed below the surface of the popping flange 224. FIG. 6 illustrates a cross-section view 600 of an arrangement of the popping flange 224 and diffuser 220. As was noted earlier, popped kernels 602 can carry unpopped kernels 604 into the container 223 of the bowl 102. When kernels pop and exit the diffuser, they enter the container 223 of the bowl 102 whereupon the popped kernels are continuously agitated by the flow of hot air and the energetic popping kernels. The results in a migration of unpopped kernels 604 downward 606 through the popped kernels 608 as the result of the aforementioned agitation and the action of gravity. The unpopped kernels 604 eventually reach the popping flange 224 where they are directed by the slope 610 (see FIG. 6A) of the popping flange 224 into the diffuser 220 for continued exposure to hot air. In an exemplary embodiment of the hot air popper, the popping flange has a range of slope 610 between 1 degree and 80 degrees. A shallow slope 610 such as illustrated in FIG. 6 provides a larger container 223 volume as the result of a wider popping flange 224 and thus a larger diameter bowl 102.

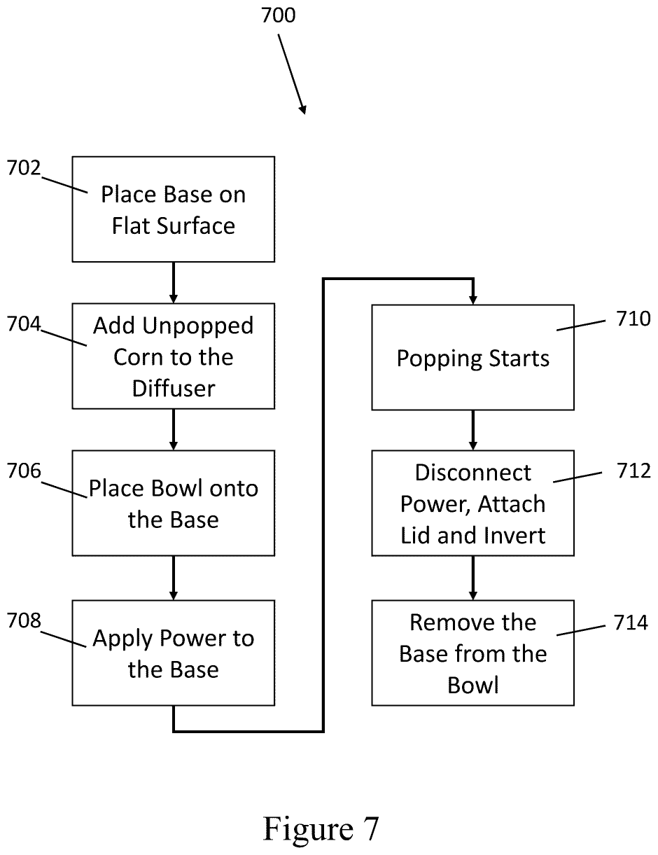

As illustrated in the flow chart 700 of FIG. 7, the base 104 is positioned on a flat surface in step 702. In step 704 unpopped kernels are placed in the diffuser 220. In step 706 the bowl is positioned on the base 104 and in step 708 power is applied to the base 104 through the use of a power cord (not illustrated in the figures). The application of power results in a stream of hot air flowing through the diffuser louvers 222 through the unpopped kernels and into the bowl 202. After a time, the kernels will start to explode into popcorn in step 710. As the hot air flows through the diffuser 220 and into the bowl 202, popcorn present in the bowl 202 is agitated such that unpopped kernels fall to the popping flange 224 and are redirected into the diffuser 220 for continued application of hot air such that the kernels pop into popcorn. When the user is satisfied that most kernels have popped, the base 102 is disconnected from power, the lid 204 snapped onto the bowl 202 and the bowl assembly 102 and base assembly 104 are inverted in step 712. The user removes the base in step 714 whereupon the user has access to the popcorn in the bowl assembly 102 for consumption.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations, and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

Any implementation or embodiment disclosed herein can be combined with any other implementation or embodiment, and references to “an implementation,” “some implementations,” “one implementation,” “an embodiment,” “some embodiments,” “certain embodiments,” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation or embodiment can be combined with any other implementation or embodiment, inclusively or exclusively, in any manner consistent with the aspects and implementations disclosed herein.

Where technical features in the drawings, detailed description, or any claim are followed by reference numbers, the reference numbers have been included to increase the intelligibility of the drawings, detailed description, and claims. Accordingly, neither the reference numbers nor their absence have any limiting effect on the scope of any claim elements.

Coupled elements can be electrically, magnetically, mechanically, or physically coupled with one another directly or with intervening elements. The scope of the systems and methods described herein is thus indicated by the appended claims, rather than the foregoing description, and changes that come within the meaning and range of equivalency of the claims are embraced therein.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes, and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions, and arrangement of the disclosed elements and operations without departing from the scope of the present disclosure.

References herein to the positions of elements (e.g., “top,” “bottom,” “above,” “below”) are merely used to describe the orientation of various elements in the Figures. The orientation of various elements may differ according to other exemplary embodiments, and that such variations are intended to be encompassed by the present disclosure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations, and locations, etc. have been described for use with disclosed embodiments, others besides those disclosed may be utilized without exceeding the scope of the claimed inventions.

What is claimed is:

1. A popcorn popper comprising:
a container formed by a bowl, a popping flange, and a popping chamber, wherein both popped and unpopped popcorn are present in the container during use, the container configured to retain the popped popcorn until popping of the unpopped corn is complete, the popping flange comprising a slope which directs unpopped popcorn located within the container into the popping chamber until popping of the unpopped popcorn is complete;
a source of heated air, the heated air directed into the popping chamber before passing through the container whereupon the popped popcorn is agitated by the heated air, the heated air exiting via an air exit formed in the bowl.

2. The popcorn popper of claim 1, wherein the popping flange is located on a base portion in which the source of heated air is enclosed.

3. The popcorn popper of claim 2, wherein the bowl is separable from the popping flange and popping chamber.

4. The popcorn popper of claim 1, wherein the air exit is formed by a grating sized to prevent passage of popped popcorn.

5. The popcorn popper of claim 1, wherein the bowl assembly also comprises a removable cap that is adapted to cover the air exit.

6. A device for popping popcorn comprising:
a base assembly comprising a diffuser, a blower, a heater, and a popping flange, the blower configured to force air through the heater and diffuser;
a bowl assembly comprising a bowl having a first end and a second end, the second end configured with vents and the first end having an opening that spans a diameter of the bowl;
the first end of the bowl adapted to be positioned on the popping flange such that the bowl and popping flange form a container which retains popped and unpopped corn during a popping process.

7. The device for popping popcorn of claim 6, wherein the bowl is formed in a cylindrical shape.

8. The device for popping popcorn of claim 6, wherein the diffuser is adapted to retain unpopped popcorn while heated air is passed through the unpopped popcorn.

9. The device for popping popcorn of claim 8, wherein the diffuser comprises vent slots, the vent slots configured to direct the heated air to create a swirling motion of unpopped popcorn located in the diffuser such that unpopped popcorn moves in a circular motion within the diffuser while exposed to the heated air.

10. The device for popping popcorn of claim 6, wherein the bowl assembly also comprising a removable cap that is adapted to cover the vents when positioned on the second end of the bowl.

11. The device for popping popcorn of claim 6, wherein the popping flange is formed in a concave shape such that the diffuser is located at a depression formed by the concave shape.

12. The device for popping popcorn of claim 11, wherein the concave shape of the popping flange comprises a concave slope between 2 degrees and 45 degrees.

13. The device for popping popcorn of claim 12, the concave shape having a slope between 5 degrees and 10 degrees.

14. A method of popping corn comprising:
placing unpopped corn into a diffuser, the diffuser comprising vent slots, the diffuser positioned in a concave popping flange;
positioning a bowl portion having an open end and a grated end such that the open end is covered with the popping flange to form a container;
causing heated air to flow through the vent slots of the diffuser such that the unpopped corn is subjected to sufficient heat that the unpopped corn pops to form popcorn;
capturing the popcorn in the container such that the popcorn is agitated by the heated air and the popping corn;
directing unpopped corn present in the container back into the diffuser for additional exposure to heated air;
positioning the bowl portion such that the popcorn is retained in the bowl portion by the force of gravity; and
removing the popping flange from the open end of the bowl portion.

15. The method of claim 14, wherein the step of directing unpopped corn is facilitated by gravity.

16. The method of claim 14, wherein the step of directing unpopped corn into the container is performed by a slope formed in the popping flange.

17. The method of claim 16, wherein the slope formed in the popping flange is a concave slope.

18. The method of claim 17, wherein the concave shape has a slope between 2 degrees and 10 degrees.

19. The method of claim 17, wherein the concave shape has a slope between 2 degrees and 45 degrees.

20. The method of claim 14, further comprising the step of applying a cover to the grated end of the bowl portion.
